(19) United States
(12) Patent Application Publication
(10) Pub. No.: US 2023/0200425 A1
(43) Pub. Date: Jun. 29, 2023

(54) NUTRITIONAL PLANT-BASED PROTEIN COMPOSITIONS WITH HIGH DIGESTIBILITY

(71) Applicant: Herbalife International of America, Inc., Los Angeles, CA (US)

(72) Inventors: Andrea Bertocco, Stanmore (GB); Jora Steennis, Wageningen (GB); Joanna Koziol, Cracow (PL); Gavin Neil Stainton, Mansfield (GB)

(21) Appl. No.: 18/169,517

(22) Filed: Feb. 15, 2023

Related U.S. Application Data
(63) Continuation of application No. PCT/US2021/047097, filed on Aug. 23, 2021.
(60) Provisional application No. 63/072,011, filed on Aug. 28, 2020.

(51) Int. Cl. A23L 33/185; A23J 3/14; A23L 33/15; A23L 33/16; A23L 2/66

(52) U.S. Cl. CPC A23L 33/185; A23J 3/14; A23L 2/66; A23L 33/15; A23L 33/16

(57) ABSTRACT

Provided herein are plant-based protein blend compositions. The protein-based composition may include pea protein, quinoa, rice protein, and flaxseed. Some embodiments provide for the composition to provide a high quality and easily digestible blend. Some embodiments also provide a plant-based protein blend with comparable digestibility to milk protein.

### FIELD

The present disclosure relates to plant-based protein compositions, and more particularly to plant-based protein blends with comparable digestibility to milk protein.

### BACKGROUND

The role of the protein in a human’s body is difficult to overestimate. It participates in virtually every process that takes place in the organism. Therefore, keeping adequate protein intake is important, and a lack of protein will give rise to health issues. Another key consideration is that proteins; unlike carbohydrates and fats are not stored by the body and so a daily and adequate intake is key. Protein is a composition of smaller molecules called Amino Acids (AA). AA in human diet can be categorized in many ways and one of the possible categorizations relies on the ability of the human body to synthesize them: indispensable (essential), dispensable, conditionally indispensable, and precursors of conditionally indispensable AA. The most nutritionally limiting are the nine indispensable AA, due to the fact that they cannot be synthesized within the human body (Hou, Yin, & Wu, 2015; Institute of Medicine, 2005; Millward, Layman, Tome, & Schaafsma, 2008). Dietary proteins containing all nine indispensable AA in amounts adequate to meet human physiological needs are considered to be “complete proteins” (Institute of Medicine, 2005).

Although proteins can vary widely in terms of their AA composition, high protein intake in general is linked with several health benefits regardless of the detailed properties of the consumed proteins. For example, protein contributes to the growth and maintenance of muscle mass and bones, it is needed for building and repairing body tissue, and it functions as enzymes and hormones while contributing to the smooth running of the immune system as well as all other systems in the human body (Institute of Medicine, 2005). A high-protein diet is usually associated with a decrease in food intake and subsequent reduction of energy intake compared to high-fat or high-carbohydrate meals (Bowen, Noakes, & Clifton, 2006; Bowen, Noakes, Trenerry, & Clifton, 2006; Dougkas & Ostman, 2016; Gentile et al., 2015; J. Li, Armstrong, & Campbell, 2016).

The most widely recognized sources of dietary protein are animal-derived such as meats, eggs and dairy. A trend of increasing consumption of red meats has been observed globally during recent decades. However, more and more research points to the fact that high consumption of red meat may lead to increased risk of several major chronic diseases, such as diabetes, coronary heart disease, heart failure, stroke and even some types of cancer (Wolk, 2017). Finally, World Cancer Research Fund developed recommendations to limit red meat consumption to prevent cancer development (WCRFI). On the other hand, meat production has a severe environmental impact on the planet and many authorities now seek for alternative protein sources to feed an increasing human population and preserve the natural environment (Wolk, 2017).

Humans are omnivores, which means that they evolved to eat and process foods from both plant and animal sources. In some cases, significant benefits appear to be linked with swapping from animal to plant protein. These benefits may include lowering risk of cardiovascular diseases, lowering blood pressure and blood lipids levels (Pedersen, Kondrup, & Børsheim, 2013). Other effects that are suggested for increased plant protein intake include reduction of risk of, among others, obesity, diabetes or gallbladder disease (Bao, Bowers, Tobias, Hu, & Zhang, 2013; Berkey et al., 2013; Bujnowski et al., 2011; Lander et al., 2016; S. S. Li et al., 2017; Liu, Colditz, Cotterchio, Boucher, & Kreiger, 2014; Malik, Li, Tobias, Pan, & Hu, 2016; Viguiliouk et al., 2015). At the same time, plant protein, if consumed in adequate amounts and in the proper combination, provides similar benefits as an adequate intake of animal protein, such as bone health or satiety (Lander et al., 2016; Nielsen et al., 2018; Thorpe, Knutsen, Beeson, Rajaram, & Fraser, 2008).

Although promising, the vast majority of plant proteins tend to be incomplete, missing various indispensable AA that are necessary for the human body -usually lysine, methionine, isoleucine, threonine and tryptophan. An example are cereals, which are deficient in lysine. Soy is an exception, with soy protein having a complete AA profile. However, it is not possible for all to eat soy – reasons can range from simple (such as taste preferences) to serious (such as risks linked to the fact that soy is a well-known allergen and its consumption may trigger a life-threatening allergic reaction). This is an area where mixing various sources of plant protein helps. In the case of cereals, lack of lysine can be easily compensated by addition of lentils. Therefore, more and more dietary guidelines suggest that vegans and vegetarians should mix a number of plant protein sources in their daily diet to deliver all necessary AA’s (Agnoli et al., 2017; Craig & Mangels, 2009; Rogerson, 2017).

Although plant protein blends may have comparable amounts of protein and AA composition to animal protein sources, the bioavailability of such mixes, i.e. ability of the body to effectively digest, absorb and use them, is lower than in the case of animal proteins (Agnoli et al., 2017; Craig & Mangels, 2009). Protein that is not digested and absorbed is removed by human body through defecation and does not support protein-dependent physiological processes. What is more, plants frequently contain substances (anti-nutrient factors), such as tannins, that might decrease bioavailability of the protein even further (Agnoli et al., 2017). Together, these facts make formulating plant protein-based meals adequate in terms of amount, quality and bioavailability of the protein a difficult and time-consuming task, that requires specialists nutritional knowledge (Rogerson, 2017). People on plant-based diets, in particular those for whom soy is not an option, are lacking easily available foods capable of providing protein that effectively meet human nutritional needs.

### SUMMARY

Some embodiments provided herein relate to a plant-based protein composition. In some embodiments, the plant-based protein composition comprises a legume protein, flax seed, a whole grain protein; and quinoa. In some embodiments, the plant-based protein composition does not contain soy or a soy-based product. In some embodiments, the legume protein is a pea protein, the flax seed is a flax seed powder, the whole grain protein is a rice protein isolate, and quinoa is a quinoa seed powder.

In some embodiments, the plant-based protein composition is about 5% to about 60% w/w flax protein, about 50% to about 80% w/w pea protein, about 3% to about 15% w/w quinoa protein, and 5% to about 20% rice protein. In some embodiments, the flax protein is 15% w/w, the pea protein is 69% w/w, the quinoa protein is 6.9% w/w, and rice protein is 9.3% w/w.

In some embodiments, the plant-based protein composition further comprises a flavoring agent, and a sweetener. In some embodiments, the plan-based protein composition further comprises coconut blossom nectar powder, inulin, oat fiber, acerola cherry extract, rice fiber, and steviol glycosides. In some embodiments, the plant-based protein composition further comprising a source of vitamin C, phosphorus, iron, zinc, copper, manganese, chromium, molybdenium, and salt. In some embodiments, the plant-based protein composition is a powder.

In some embodiments, the plant-based protein composition is formulated as a food product or a food product supplement.

Some embodiments provided herein relate to a method of providing a plant-based protein composition with comparable digestibility to milk protein. In some embodiments, the method comprises providing a plant-based protein composition comprising a flax protein, a pea protein, a quinoa protein, and a rice protein. In some embodiments, the plant-based protein composition does not contain soy or a soy-based product.

In some embodiments, the plant-based protein composition provides an in-vitro digestibility of essential amino acids at about 72.2% histidine, about 82.1% isoleucine, about 75.7% leucine, about 77.4% lysine, about 51.5% methionine, about 73.1% phenylalanine, about 72.8% tryptophan, and about 70.7% valine. In some embodiments, the plant-based protein composition provides about 90% digestibility of milk protein.

In some embodiments, the plant-based protein composition is provided at least one, two, three, four or five times per day. In some embodiments, the plant-based protein composition is provided at a meal. In some embodiments, the plant-based protein composition is provided in a beverage to the subject.

Some embodiments provided herein relate to a plant-based wellness protein shake product that is absent of soy and dairy products. In some embodiments, the plant-based wellness protein shake product comprises about 90% to 99% of a plant-based protein composition and about 1% to about 10% water.

Some embodiments provided herein relate to a method of making a plant-based protein shake product that is absent of soy and dairy products. In some embodiments, the method comprises mixing a plant-based protein composition in water to achieve a desired thickness. In some embodiments, the mixing is in a blender. In some embodiments, the method further comprises adding ice to the plant-based protein composition in water. In some embodiments, the method further comprises adding fresh fruits and vegetables to the plant-based protein composition in water.

Some embodiments provided herein relate to a plant-based protein composition that provides complete and easily digestible plant protein. In some embodiments, the plant-based protein composition effectively satisfies the protein requirements of adults. In some embodiments, the plant-based protein compositions have complete indispensable amino acid profiles. In some embodiments, the plant-based protein composition does not contain a highly processed additive. In some embodiments, the plant-based protein composition provides a complete indispensable amino acid provide, high digestibility and does not contain a highly processed additive for improving protein quality.

Some embodiments provided herein relate to a plant-based protein composition that provides a complete plant protein in small portion of food. In some embodiments, the plant-based protein composition has excellent protein density. In some embodiments, the plant-based protein composition provides a single serving that weighs 40 g and provides as much as 29 g of a complete protein. In some embodiments, the plant-based protein composition that provides the protein requirements of a subject when served in relatively small amounts without using soy protein.

Some embodiments provided herein relate to a plant-based protein composition to meet the protein requirements of children. In some embodiments, the plant-based protein composition provides sufficient protein levels to satisfy the needs of a child’s rapid development and body maintenance.

### BRIEF DESCRIPTION OF THE DRAWINGS

The abovementioned and other features disclosed herein are described below with reference to the drawings of the preferred embodiments. The illustrated embodiments are intended to illustrate, but not to limit the disclosure. The drawings contain the following figures.

FIG. 1 provides an in-vitro digestibility of the different protein samples for the individual amino acids (AA) and the averages for essential AA (EAA), non-essential AA (NEAA), and the total AA.

FIG. 2 provides an in-vitro filtrate amino acid scores (IVFAAS) and rate limiting amino acids.

FIG. 3 illustrates an IVFAAS digestibility score and the rate limiting AA for the protein samples normalized by Kjedhal (6.25) in comparison with the WHO recommendations for infants in age 6-36 months.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Accordingly, described herein are plant-based protein compositions. The plant-based protein compositions may provide a source of complete and bioavailable protein suitable for people on plant-based diets including those allergic to soy, and does not require a high level of nutritional knowledge in preparation. Combining all these features in one product produces a high quality and easily digestible blend. Additional features of the plant-based protein composition may provide comparable digestibility to milk protein.

### Compositions

Some embodiments relate to a plant-based protein composition. In some embodiments, the plant-based protein composition provides a complete set of amino acids (AA) as required by a human body. In some embodiments, the plant-based protein composition is easily digestible. In some embodiments, the plant-based protein composition does not contain soy or a soy protein.

In some embodiments, the plant-based protein composition comprises a legume protein, flax seed, a whole grain protein, and quinoa. In some embodiments, the plant-based protein composition comprises pea protein, flax seed, rice protein, and quinoa. In some embodiments, the plant-based protein composition comprises pea protein isolate, flax seed powder, rice protein isolate, and quinoa seed powder. In some embodiments, the plant-based protein composition does not contain soy or a soy-based product.

In some embodiments, the whole grain protein is derived from rice. In some embodiments, the whole grain protein comprises a rice protein. In some embodiments, the whole grain protein comprises a rice protein isolate. In some embodiments, the whole grain protein comprises a rice protein concentrate. Suitable rice protein concentrates comprise, for example, at least about 70% protein. Suitable rice protein isolates comprise, for example, at least about 90% protein. Suitable whole grain proteins are readily available from any number of manufacturers. In some embodiments, the whole grain protein comprises between about 70% and about 90% protein.

In some embodiments, the legume protein is derived from pea. In some embodiments, the legume protein comprises a pea protein. In some embodiments, the legume protein comprises a pea protein isolate. In some embodiments, the legume protein comprises a pea protein concentrate. Suitable pea protein concentrates comprise, for example, at least about 70% protein. Suitable pea protein isolates comprise, for example, at least about 90% protein. Suitable pea proteins are readily available from any number of manufacturers. In some embodiments, the pea protein comprises between about 70% and about 90% protein.

In some embodiments, the plant-based protein composition may comprise: about 5% to about 60% w/w flax protein; about 40% to about 80% w/w pea protein; about 3 to about 15% w/w quinoa protein; and 5 to about 20% rice protein. In some embodiments, the plant-based protein composition may comprise: about 5 to about 40% w/w flax protein; about 50 to about 80% w/w pea protein; about 5 to about 15% w/w quinoa protein; and 5 to about 15% rice protein. In some embodiments, the plant-based protein composition may comprise: about 10 to about 20% w/w flax protein; about 60 to about 75% w/w pea protein; about 5 to about 10% w/w quinoa protein; and 5 to about 15% rice protein. In some embodiments, the plant-based protein composition may comprise: about 12% to about 17% w/w flax protein; about 65% to about 75% w/w pea protein; about 5% to about 10% w/w quinoa protein; and about 7% to about 12% rice protein. In some embodiments, the plant-based protein composition may comprise: about 15% w/w flax protein; about 69% w/w pea protein; about 7% w/w quinoa protein; and 10% rice protein. In some embodiments, the plant-based protein composition may comprise: about 15% w/w flax protein; about 69% w/w pea protein; about 6.9% w/w quinoa protein; and 9.3% rice protein.

The plant-based protein composition provided herein can further include one or more additional ingredients. In some embodiments, the plant-based protein compositions described herein may further comprise one or more of acids, including, for example citric acid, phosphoric acid, ascorbic acid, sodium acid sulfate, lactic acid, or tartaric acid; bitter ingredients, including, for example caffeine, quinine, green tea, catechins, polyphenols, green robusta coffee extract, green coffee extract, or potassium chloride; coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide; preservatives, including, for example sodium benzoate, potassium benzoate, potassium sorbate, sodium metabisulfate, sorbic acid, or benzoic acid; antioxidants including, for example ascorbic acid, calcium disodium EDTA, alpha tocopherols, mixed tocopherols, rosemary extract, grape seed extract, resveratrol, or sodium hexametaphosphate; vitamins or functional ingredients including, for example resveratrol, Co-Q10, omega 3 fatty acids, theanine, choline chloride (citocoline), fibersol, inulin (chicory root), taurine, panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate; clouding agents, including, for example ester gun, brominated vegetable oil (BVO), or sucrose acetate isobutyrate (SAIB); buffers, including, for example sodium citrate, potassium citrate, or salt; flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), or carrageenan. In some embodiments, the one or more additional ingredients in the plant-based composition may comprise 0.1%, 0.2%, 0.3%, 0.4%, 0.5%, 0.7%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10% wt/wt, or ranges including and/or spanning the aforementioned values.

In some embodiments, the plant-based protein compositions provided herein may further include at least one of carbohydrates, soluble fiber, flavorants, artificial sweeteners, preservatives, fillers, thickeners, colorants, and any other food safe additive. In some embodiments, the plant-based protein composition may further comprise at least one of plant-based oils, vitamins, minerals, preservatives, emulsifying agents, thickeners, or a combination thereof. In some embodiments, the vitamins is vitamin C. In some embodiments, the minerals may include one or more of iron, zinc, copper, manganese, chromium, molybdenium, and salt. In some embodiments, the salt may be selected from table salt, kosher salt, sodium chloride, magnesium chloride, potassium chloride, sea salt, table salt, fleur de sel, pink salt, Himalayan salt, Hawaiian alaea red salt, or a combination thereof. The plant-based protein composition, alone or in combination with one or more of the additional ingredients, can then be included in a foodstuff or beverage by methods known in the field of food and beverage processing, such as simple mixing. In some embodiments, at least one of carbohydrates, soluble fiber, flavorants, artificial sweeteners, preservatives, fillers, thickeners, colorants, and any other food safe additive in the plant-based composition may comprise 0.1%, 0.2%, 0.3%, 0.4%, 0.5%, 0.7%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10% wt/wt, or ranges including and/or spanning the aforementioned values. The plant-based protein composition provided herein may further comprise a sweetener. In some embodiments, one or more sweetener is added to the plant-based protein composition with sweet flavor including without any limitation any natural or synthesized sweet flavor compound that elicits a perception of sweetness. In some embodiments, the one or more sweetener is one or more of a non-caloric sweetener, a reduced calorie sweetener, or a non-target caloric sweetener. The sweetener can be any sweetener described or referenced herein, alone or in combination with any additional sweetener or sweeteners described or referenced herein. In some embodiments, the sweetener is a natural sweetener. In some embodiments, the sweetener is an artificial sweetener. In some embodiments, the sweetener is a combination of a natural sweetener and an artificial sweetener. In some embodiments, the sweeter in the plant-based composition may comprise 0.1%, 0.2%, 0.3%, 0.4%, 0.5%, 0.7%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10% wt/wt, or ranges including and/or spanning the aforementioned values.

Natural or artificial sweeteners for use in the plant-based protein compositions may comprise one or more sweetener in combination with one or more flavor modifying compound include but are not limited to natural or synthetic carbohydrates or carbohydrate analogues, including monosaccharides, disaccharides, oligosaccharides, and polysaccharides, and including rare sugars, or sugars in either of the D- or L-conformations, and include, for example, sucrose, fructose, glucose, L-arabinose, L-fucose, L-glucose, L-ribose, D-arabino-hexulose, psicose, altrose, arabinose, turanose, abequose, allose, abrusoside A, aldotriose, threose, xylose, xylulose, xylo-oligosaccharide (such as xylotriose and xylobiose), lyxose, polydextrose, oligofructose, fucose, galacto-oligosaccharide, galactosamine, galactose, gentio-oligosaccharide (such as gentiobiose, gentiotriose, and gentiotetraose), dextrose, cellobiose, D-leucrose, D-psicose, D-ribose, D-tagatose, trehalose (mycose), neotrehalose, isotrehalose, raffinose, idose, tagatose, melibiose, mannan-oligosaccharide, rhamnose, ribose, ribulose, malto-oligosaccharide (such as maltotriose, maltotetraose, maltopentaose, maltohexaose, and maltoheptaose), maltose, sucrose acetate isobutyrate, dextrose, erythrose, erythrulose, deoxyribose, gulose, ketotriose, lactose, lactulose, kestose, nystose, mannose, sucralose, palatinose, polydextrose, sorbose, sugaridextrose (blended sugar), or talose, or combinations of any two or more of the aforementioned sweeteners.

The one or more sweetener can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The one or more sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside I (including mogrosides I_{A} and I_{E}), mogroside II (including mogrosides II_{A}, II_{A1}, II_{A2}, II_{B}, and II_{E}), mogroside III (including mogroside III_{A2}, III_{E}), mogroside IV (including mogrosides IV_{A} and IV_{E}), mogroside V, and mogroside VI), 7-oxomogrosides (including, for example, 7-oxomogroside II_{E} and 7-oxomogroside V), 11-deoxymogrosides (including, for example, 11-deoxymogrosides III and V), 11-oxomogrosides (including, for example, 11-oxomogrosides I_{A}, III_{E}, IV, IV_{A}, IV_{E}, V, and VI), siamenoside, siamenoside I, isomogroside, isomogroside V, mogrol, 11-oxomogrol, neomogroside, mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

The plant-based protein composition described herein may further comprise a at least one additive component selected from the group comprising of a binding agent, a moisture-absorbing component, a film-forming agent, a dispersing agent, an antisticking component, a bulking agent, or a combination thereof.

The plant-based protein composition described herein may contain aroma agents or flavoring agents including natural and synthetic flavorings e.g. in the form of natural vegetable components, essential oils, essences, extracts, powders, including acids and other substances capable of affecting the taste profile. Examples of liquid and powdered flavorings include coconut, coffee, chocolate, vanilla, grape, grapefruit, orange, lime, menthol, liquorice, caramel aroma, honey aroma, peanut, walnut, cashew, hazelnut, almonds, pineapple, strawberry, raspberry, tropical fruits, cherries, cinnamon, peppermint, wintergreen, spearmint, eucalyptus, and mint, fruit essence such as from apple, pear, peach, strawberry, apricot, raspberry, cherry, pineapple, and plum essence. The essential oils include peppermint, spearmint, menthol, eucalyptus, clove oil, bay oil, anise, thyme, cedar leaf oil, nutmeg, and oils of the fruits mentioned above. In some embodiments, the aroma agents or flavoring agents in the plant-based composition may comprise 0.1%, 0.2%, 0.3%, 0.4%, 0.5%, 0.7%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10% wt/wt, or ranges including and/or spanning the aforementioned values.

The plant-based protein composition described herein may be in the form of a solid. In some embodiments, the plant-based protein composition described herein may be in the form of a powder. In some embodiments, the plant-based protein composition described herein may be in the form of granules. In some embodiments, the plant-based protein composition described herein may be in the form of flakes. In some embodiments, the plant-based protein composition described herein may be in the form of pellets. In some embodiments, the plant-based protein composition described herein may be a combination of a powder, granules, flakes, or pellets.

### Foodstuffs

Some embodiments provide adding the plant-based protein composition as a supplement, nutraceutical, functional food product, and animal feed products.

In some embodiments, the one or more plant-based protein compositions provided herein may be added to food or beverage products or formulations. In some embodiments, the food and beverage products or formulations include, but are not limited to, soups, dried and culinary processed foods, ready meals, canned or preserved foods, frozen processed foods, chilled processed foods, snake foods, baked goods, ice creams, meal replacement foods, sauces, and baby foods. In some embodiments, the plant-based protein composition is added to ice. In some embodiments, the plant-based protein composition is added to fresh fruits. In some embodiments, the plant-based protein composition is added to vegetables.

In general, soups refers to Soup category refers to canned/preserved, dehydrated, instant, chilled, UHT and frozen soup. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).

In general dried and culinary foods usually means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

Beverages usually means beverages, beverage mixes and concentrates, including but not limited to, carbonated and non-carbonated beverages, ready to drink beverages, and dry powdered beverage precursor mixes. Beverages also includes sports drinks, isotonic beverages, hot drinks, fruit juice, such as juice, nectars, juice drinks and fruit flavored drinks; bottled water, which includes sparkling water, spring water, purified/table water, and vitamin water; functional drinks, which can be carbonated or still and include sport, energy or elixir drinks. The drinks, either hot or cold, include, but are not limited to coffee or ice coffee, such as fresh, instant, and combined coffee; tea or ice tea, such as black, green, white, oolong, and flavored tea; and other drinks including flavor-, malt- or plant-based powders, granules, blocks or tablets mixed with milk or water.

Snack foods generally refers to any food that can be a light informal meal including, but not limited to sweet and savory snacks and snack bars. Examples of snack food include, but are not limited to fruit snacks, chips/crisps, extruded snacks, tortilla/corn chips, popcorn, pretzels, nuts and other sweet and savory snacks. Examples of snack bars include, but are not limited to granola/muesli bars, breakfast bars, energy bars, fruit bars and other snack bars.

Baked goods generally refers to any edible product the process of preparing which involves exposure to heat or excessive sunlight. Examples of baked goods include, but are not limited to bread, buns, cookies, muffins, cereal, toaster pastries, pastries, waffles, tortillas, biscuits, pies, bagels, tarts, quiches, cake, any baked foods, and any combination thereof.

Ice creams generally refers to frozen dessert containing cream and sugar and flavoring. Examples of ice cream include, but are not limited to: impulse ice cream; take-home ice cream; frozen yoghurt and artisanal ice cream; gelato; sorbet; sherbet; soy, oat, bean (e.g., red bean and mung bean), coconut, nut and rice-based ice creams.

Meal replacement generally refers to any food intended to replace the normal meals, particularly for people having health or fitness concerns. Examples of meal replacement include, but are not limited to slimming products, protein shake products, nutritional shake products, and convalescence products.

Ready meal generally refers to any food that can be served as meal without extensive preparation or processing. The ready meal includes products that have had recipe “skills” added to them by the manufacturer, resulting in a high degree of readiness, completion and convenience. Examples of ready meal include, but are not limited to canned/preserved, frozen, dried, chilled ready meals; dinner mixes; frozen pizza; chilled pizza; and prepared salads.

Canned/preserved foods generally include, but are not limited to canned/preserved meat and meat products, fish/seafood, vegetables, tomatoes, beans, fruit, ready meals, soup, pasta, and other canned/preserved foods.

Frozen processed foods generally include, but are not limited to frozen processed red meat, processed poultry, processed fish/seafood, processed vegetables, meat substitutes, processed potatoes, bakery products, desserts, ready meals, pizza, soup, noodles, and other frozen food.

Dried processed foods generally includes, but are not limited to rice, dessert mixes, dried ready meals, dehydrated soup, instant soup, dried pasta, plain noodles, and instant noodles. The Chill Processed Food category includes, but is not limited to chilled processed meats, processed fish/seafood products, lunch kits, fresh cut fruits, ready meals, pizza, prepared salads, soup, fresh pasta and noodles.

Sauces generally includes, but are not limited to tomato pastes and purees, table sauces, soy based sauces, pasta sauces, wet/cooking sauces, dry sauces/powder mixes, ketchup, mayonnaise, mustard, salad dressings, vinaigrettes, dips, pickled products, and other sauces, dressings and condiments.

Baby foods generally includes, but are not limited to formulas; and prepared, dried and other baby food.

### Methods of Use

Some embodiments relate to a method of providing a plant-based protein composition with comparable digestibility to milk protein. In some embodiments, the method comprises providing a plant-based protein composition as described herein. In some embodiments, the plant-based protein composition comprises a legume protein, flax seed, a whole grain protein, and quinoa. In some embodiments, the plant-based protein composition comprises pea protein, flax seed, rice protein, and quinoa. In some embodiments, the plant-based protein composition comprises pea protein isolate, flax seed powder, rice protein isolate, and quinoa seed powder. In some embodiments, the plant-based protein composition does not contain soy or a soy-based product.

In some embodiments, the plant-based protein composition provides an in-vitro digestibility of essential amino acids at about 70% to about 75% histidine, about 80% to about 85% isoleucine, about 72% to about 78% leucine, about 75% to about 80% lysine, about 50% to about 55% methionine, about 70% to about 75% phenylalanine, about 70% to about 75% tryptophan, and about 65% to about 75% valine. In some embodiments, the plant-based protein composition provides an in-vitro digestibility of essential amino acids at about 72.2% histidine, about 82.1% isoleucine, about 75.7% leucine, about 77.4% lysine, about 51.5% methionine, about 73.1% phenylalanine, about 72.8% tryptophan, and about 70.7% valine.

In some embodiments, the comparable digestibility to milk protein is about 70%, 75%, 80%, 85%, 90%, 95%, 99%, or ranges including and/or spanning the aforementioned values, comparable digestibility to milk protein. In some embodiments, the comparable digestibility to milk protein is about 80%. In some embodiments, the comparable digestibility to milk protein is about 90%. In some embodiments, the comparable digestibility to milk protein is about 95%.

In some embodiments, the plant-based protein composition is provided once a day. In some embodiments, the plant-based protein composition is provided at least twice a day. In some embodiments, the plan-based protein composition is provided at least three thrice a day. In some embodiments, the plant-based protein composition is provided at least four or five times per day. In some embodiments, the plant-based protein composition is provided once a week. In some embodiments, the plant-based protein composition is provided twice a week. In some embodiments, the plant-based protein composition is provided three times a week. In some embodiments, the plant-based protein composition is provided four times a week. In some embodiments, the plant-based protein composition is provided once a month. In some embodiments, the plant-based protein composition is provided twice a month. In some embodiments, the plant-based protein composition is provided three times a month. In some embodiments, the plant-based protein composition is provided four times a month.

In some embodiments, the plant-based protein composition is provided at a meal. In some embodiments, the plant-based protein composition is provided before a meal. In some embodiments, the plant-based protein composition is provided after a meal. In some embodiments, the plant-based protein composition is provided in between meals.

In some embodiments, the plant-based protein composition is provided as a beverage to the subject.

Some embodiments relate to a method of providing a complete and easily digestible plant-protein composition. In some embodiments, the method comprises providing a plant-based protein composition as described herein. In some embodiments, the plant-based protein composition comprises a legume protein, flax seed, a whole grain protein, and quinoa. In some embodiments, the plant-based protein composition comprises pea protein, flax seed, rice protein, and quinoa. In some embodiments, the plant-based protein composition comprises pea protein isolate, flax seed powder, rice protein isolate, and quinoa seed powder.

Some embodiments relate to a method of providing a complete plant-based protein composition in a small portion of food. In some embodiments, the method comprises providing a plant-based protein composition as described herein. In some embodiments, the plant-based protein composition comprises a legume protein, flax seed, a whole grain protein, and quinoa. In some embodiments, the plant-based protein composition comprises pea protein, flax seed, rice protein, and quinoa. In some embodiments, the plant-based protein composition comprises pea protein isolate, flax seed powder, rice protein isolate, and quinoa seed powder.

Some embodiments relate to a method of meeting a nutritional requirement in a subject in need thereof. In some embodiments, the method comprises administering a plant-based protein composition as described herein. In some embodiments, the plant-based protein composition comprises a legume protein, flax seed, a whole grain protein, and quinoa. In some embodiments, the plant-based protein composition comprises pea protein, flax seed, rice protein, and quinoa. In some embodiments, the plant-based protein composition comprises pea protein isolate, flax seed powder, rice protein isolate, and quinoa seed powder.

Some embodiments relate to a method of providing a plant-based protein not containing soy or soy-derived ingredients. In some embodiments, the method comprises administering a plant-based protein composition as described herein. In some embodiments, the plant-based protein composition comprises a legume protein, flax seed, a whole grain protein, and quinoa. In some embodiments, the plant-based protein composition comprises pea protein, flax seed, rice protein, and quinoa. In some embodiments, the plant-based protein composition comprises pea protein isolate, flax seed powder, rice protein isolate, and quinoa seed powder.

In some embodiments, the plant-based protein compositions described herein is prepared for animal consumption as an animal feed product, or as an ingredient in animal feed. As used herein, “animal feed” means a product or composition of primarily biological origin that can be consumed by an animal and that provides nutrition for that animal. An animal feed may be a “compound feed” that is blended from multiple raw materials and is generally formulated to meet the specific needs of a target animal. An animal feed product can include pellets, cakes, meal, crumbles, granules, drinks, slurries, slops, and so forth. An animal feed can be supplemented with vitamins, minerals, preservatives, antibiotics, amino acids, pigments, and other additives; these supplements may be supplied as part of a commercial feed or as additives used by farmers, ranchers, and herders on grains purchased or grown separately.

In some embodiments, the plant-based protein compositions described herein can be added to nutritional products, dietary supplements, or over-the counter medications.

### EXAMPLES

Embodiments of the present disclosure are further defined in the following Examples. It should be understood that these Examples are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims. The disclosure of each reference set forth herein is incorporated herein by reference in its entirety.

### Example 1 – Triblend Plant Based Protein Composition

A plant-based protein composition blend (further called Triblend) is a composition of 4 plant ingredients: pea protein (69%), quinoa (6.9%), rice protein (9.3%) and flaxseed (15%). The Triblend comprises 72% of this protein blend. The Triblend provides high amounts of plant protein which are simultaneously complete/high quality (i.e. its amino acids (AA) composition match quantitatively and qualitatively human nutritional requirements as specified by WHO) (WHO, 2007) and easily digestible (Ariens, de Jong, Wichers, & Mes, 2019). Plant proteins are known for their low digestibility, which limits their nutritional value (Agnoli et al., 2017; Craig & Mangels, 2009), but Triblend was successfully composed to achieve a protein quality comparable to animal protein known for its high nutritional value, such as milk protein (Dupont & Tome, 2014). Therefore, it solves the problem of people on plant-based diets who lack high quality and easily digestible protein sources, by providing a plant-based blend capable of fulfilling their protein needs.

### Example 2 – Triblend Plant Based Protein Composition Formulation

A mix of 20 g (69%) pea protein isolate, 4.2 g (15%) flax seed powder, 2.68 g (9.3%) rice protein isolate and 2 g (6.9%) quinoa seed powder. The mix is blended to a uniform blend. The mix may further include a source of vitamins and minerals, coconut blossom nectar powder, inulin, oat fiber, acerola cherry extract, and steviol glycosides.

### Example 3 – Triblend Plant-based Protein Composition Digestibility

There are several ways to express the quality of a protein. One of the most recognized by authorities is “Protein Digestibility Corrected Amino Acid Score” (PDCAAS). It scores protein on the basis of its AA composition and digestibility. The score is then compared to the protein requirements defined for populations of a specified age range. The highly-demanding protein needs of pre-school children were used to calculate its PDCAAS score to assure the highest quality of the plant-based protein composition and to account for adult populations with an above average protein requirement (e.g. with high level of physical activity) (WHO, 2007). A newer method of expressing protein quality is the Digestible Indispensable Amino Acid Score (DIAAS). This method accounts for the AA profile and then corrects it with the digestibility of individual AA’s, not the whole protein. The downside of DIAAS is that based on end of ileum AA analysis in animals like rats or piglets. For that reason, several alternative in-vitro assessments have been introduced to assess DIAAS, like In Vitro Digestion Filtrate Amino Acid Score (IVFAAS). This method, takes AA composition and the (in-vitro) digestibility of the individual AA into account, making it a direct method to determine protein quality and makes it possible to make comparisons between different ingredients (Havenaar et al., 2016). Similarly, to PDCAAS, IVFAAS score includes comparison to protein requirements of relevant population.

If considered separately, the proteins within the ingredients of plant-based protein composition cannot be called high quality. On their own, they don’t have the right balance of indispensable AA and each protein has insufficient level of at least one of them, This is reflected by their individual PDCAAS values: rice protein isolate 0.5-0.8, pea protein isolate 0.6-0.9, quinoa seed powder 0.7-0.9 and flax seed powder 0.7-0.8, as shown both by literature and biochemical analyses of the individual ingredients (Giacomino et al., 2013; Marinangeli & House, 2017; Nosworthy et al., 2017; Ruales & Nair, 1992). Pea protein is low in sulphur amino acids (cysteine and methionine) and the proteins of flax, rice and quinoa are low in lysine. However, when mixed in the proper ratios, the plant-based protein composition combines to form a complete protein, achieving a PDCAAS of 1 both in theoretical calculations as well as in biochemical analyses (see Tables 1, 2 and 3). This is comparable to milk protein (mainly casein protein (~80%), the rest is whey protein) which reaches the highest PDCAAS score of 1 (Marinangeli & House, 2017).

Table 1 below provides for an amino acid composition and digestibility of protein sources in a plant-based protein blend.

TABLE 1

| | Pea protein | Quinoa powder | Flax powder | Rice protein |
|---|---|---|---|---|
| Protein Digestibility | 98%* | 86%* | 85%** | 93%* |
| Amino acid composition (g per 100 g of raw material)** | | | | |
| Histidine | 1.903 | 0.433 | 0.678 | 1.867 |
| Isoleucine | 3.670 | 0.605 | 1.316 | 3.472 |
| Leucine | 6.579 | 1.003 | 1.923 | 6.839 |
| Lysine | 5.841 | 0.786 | 1.235 | 2.432 |
| Threonine | 3.109 | 0.587 | 1.324 | 3.051 |
| Tryptophan | 0.677 | 0.181 | 0.508 | 1.031 |
| Valine | 3.910 | 0.716 | 1.577 | 4.910 |
| Phenylalanine | 4.363 | 0.623 | 1.477 | 4.478 |
| Tyrosine | 3.177 | 0.468 | 0.834 | 4.607 |
| Methionine | 0.789 | 0.306 | 0.611 | 2.337 |
| Cysteine | 0.985 | 0.246 | 0.626 | 1.944 |

Table 2 below provides for an amino acid composition and PDCAAS assessment of a plant-based protein blend.

TABLE 2

| Amino Acid | Raw material contributions (g/serving)* | | | | Corrected AA score** |
|---|---|---|---|---|---|
| | Pea protein | Quinoa Powder | Flax Powder | Rice protein | |
| Histidine | 0.373 | 0.007 | 0.024 | 0.047 | 1.29 |
| Isoleucine | 0.719 | 0.010 | 0.047 | 0.087 | 1.43 |
| Leucine | 1.289 | 0.017 | 0.069 | 0.170 | 1.26 |
| Lysine | 1.145 | 0.014 | 0.044 | 0.061 | 1.25 |
| Threonine | 0.609 | 0.010 | 0.047 | 0.076 | 1.42 |
| Tryptophan | 0.133 | 0.003 | 0.018 | 0.026 | 1.32 |
| Valine | 0.766 | 0.012 | 0.056 | 0.122 | 1.20 |
| Phenyloalanine/ Tyrosine | 0.855 / 0.623 | 0.011 / 0.008 | 0.053 / 0.030 | 0.112 / 0.115 | 2.02 |
| Methionine/Cysteine | 0.155 / 0.193 | 0.005 / 0.004 | 0.022 / 0.022 | 0.058 / 0.048 | 1.05 |
| PDCAAS | 1 | | | | |

Table 3 below provides for an amino acid composition and PDCAAS assessment of a plant-based protein blend.

TABLE 3

| External lab | Ansynth | Eurofins, batch 1 | Eurofins, batch 2 |
|---|---|---|---|
| Amino Acid composition (mg/g protein)* | | | |
| Histidine | 26.70 | 25.22 | 24.22 |
| Isoleucine | 51.44 | 46.73 | 46.02 |
| Leucine | 90.94 | 85.70 | 83.31 |
| Lysine | 74.06 | 70.01 | 66.84 |
| Threonine | 43.63 | 39.13 | 38.27 |
| Tryptophan | 10.85 | 11.66 | 12.43 |
| Valine | 56.87 | 53.52 | 52.31 |
| Phenyloalanine / Tyrosine | 61.17 / 44.44 | 57.24 / 39.78 | 55.87 / 39.24 |
| Methionine / Cysteine | 14.61 / 15.94 | 15.34 / 12.58 | 13.56 / 12.85 |
| Lowest corrected AA score** | 1.18 | 1.08 | 1.02 |
| PDCAAS | 1 | | |

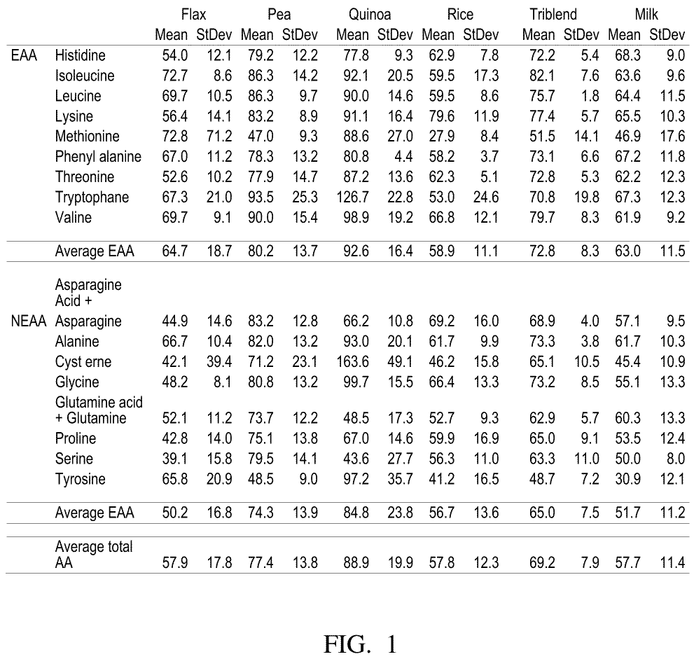

An embodiment of the plant-based protein compositions described herein were designed not only to achieve complete AA profile but also to assure its efficacy in actually delivering protein to the human body. Despite being a blend of plant proteins, the unique composition of the plant-based protein composition includes ingredients with high digestibility that allows the blend to be digested easily, at a rate comparable to one of the most easily digested animal proteins - milk protein (Dupont & Tome, 2014). This was shown by studies performed by Wageningen University & Research (Ariens et al., 2019). The average in-vitro digestibility of essential AAs in Triblend was 72.8% (±8.3%) and that of milk protein was 63.0% (±11.5%) (FIG. 1). FIG. 1 provides an in-vitro digestibility of the different protein samples for the individual amino acids and the averages for essential AA (EAA), non-essential AA (NEAA), and the total AA. Values in FIG. 1 are represented as a %. Digestions were performed in triplicate and AA were analyzed in duplicates for each digest except for methionine and cysteine which were analyzed once for each digest. Full description of the method and analyses can be found in the study report (Ariens et al., 2019).

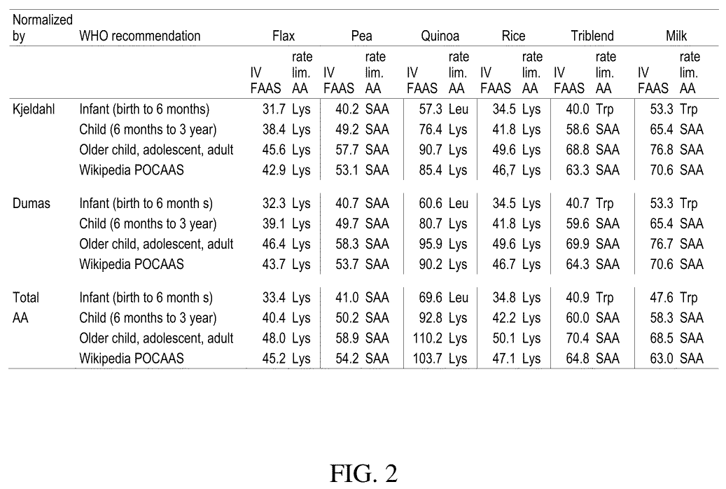

When ranking other ingredients from best to least well-digestible, quinoa has the best digestibility followed by pea>plant-based protein composition>flax>milk>rice. IVFAAS was 58.6% for Triblend and 65.4% for milk protein. Limiting AA in milk and Triblend were sulphur amino acids (FIG. 2). FIG. 2 provides an in-vitro filtrate amino acid scores (IVFAAS) and rate limiting amino acids. The scores and rate limiting amino acids were based on three different protein quantification methods - Kjeldahl, Dumas, and total amino acids. The amino acid scoring patterns used were taken from FAO (FAO, 2013). Full description of the method and analyses can be found in the study report (Ariens et al., 2019).

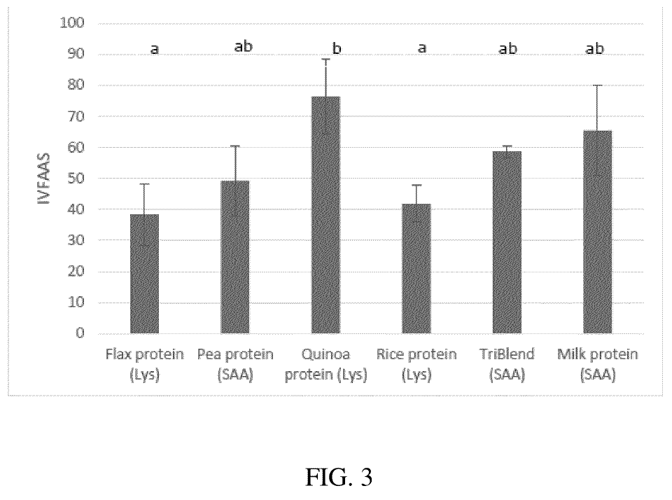

A plant-based protein composition of Example 1 IVFAAS was not significantly different compared to milk protein and therefore could be considered comparable (FIG. 3). FIG. 3 provides an IVFAAS digestibility score and the rate limiting AA for the protein samples normalized by Kjedhal (6.25) in comparison with the WHO recommendations for infants in age 6-36 months. Bars are means and 1 SD. Significant differences are indicated by a and b (samples with the same letter are not significant different) based on ANOVA followed by a Bonferroni corrected post-hoc test (p<0.05). Full description of the methods and analyses can be found in the study report (Ariens et al., 2019).

When ranking IVFAAS of all ingredients quinoa has the highest IVFAAS followed by milk>plant-based protein composition>pea>rice>flax.

What is more, unlike soy and dairy protein, the plant proteins in plant-based protein composition are not derived from the most common allergenic foods, such as soy or wheat. This reduces the risk of triggering an allergic reaction, making the blend a nutritious option for a wide population of adults with allergies (EFSA, 2014; FDA, 2017).

The disclosure is generally described herein using affirmative language to describe the numerous embodiments. The disclosure also includes embodiments in which subject matter is excluded, in full or in part, such as substances or materials, method steps and conditions, protocols, or procedures.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “about” or “approximately” means within an acceptable error range for the particular value as determined by one of ordinary skill in the art, which will depend in part on how the value is measured or determined, e.g., the limitations of the measurement system. For example, “about” can mean within 1 or more than 1 standard deviations, per the practice in the art. Alternatively, “about” can mean a range of up to 20%, up to 10%, up to 5%, and up to 1% of a given value. Alternatively, particularly with respect to biological systems or processes, the term can mean within an order of magnitude, within 5-fold, and within 2-fold, of a value. Where particular values are described in the application and claims, unless otherwise stated the term “about” meaning within an acceptable error range for the particular value should be assumed.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a nonlimiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A plant-based protein composition, comprising:
legume protein;
flax seed;
whole grain protein; and
quinoa,
wherein the plant-based protein composition does not contain soy or a soy-based product.

2. The plant-based protein composition of claim 1, wherein no dairy products are present, but the digestibility of the composition is comparable to milk protein, and wherein the legume protein is a pea protein, the flax seed is a flax seed powder, the whole grain protein is a rice protein isolate, and the quinoa is a quinoa seed powder.

3. The plant-based protein composition of claim 2, wherein the plant-based protein composition is about 5% to about 60% w/w flax protein, about 50% to about 80% w/w pea protein, about 3% to about 15% w/w quinoa protein, and 5% to about 20% rice protein.

4. The plant-based protein composition of claim 2, wherein the flax protein is 15% w/w, the pea protein is 69% w/w, the quinoa protein is 6.9% w/w, and rice protein is 9.3% w/w.

5. The plant-based protein composition of claim 1, further comprising a flavoring agent, and a sweetener.

6. The plant-based protein composition of claim 1, further comprising coconut blossom nectar powder, inulin, oat fiber, acerola cherry extract, rice fiber, and steviol glycosides.

7. The plant-based protein composition of claim 1, further comprising vitamin C, phosphorus, iron, zinc, copper, manganese, chromium, molybdenium, and salt.

8. The plant-based protein composition of claim 1, wherein the plant-based protein composition is a powder.

9. A food product containing the plant-based protein composition of claim 1.

10. A method of providing a plant-based protein composition with comparable digestibility to milk protein, comprising:
providing to a subject a plant-based protein composition comprising a flax protein, a pea protein, a quinoa protein, and a rice protein,
wherein the plant-based protein composition does not contain soy or a soy-based product.

11. The method of claim 10, wherein the plant-based protein composition is about 5% to about 60% w/w flax protein, about 50% to about 80% w/w pea protein, about 3% to about 15% w/w quinoa protein, and 5% to about 20% rice protein.

12. The method of claim 10, wherein the flax protein is about 15% w/w, the pea protein is 69% w/w, the quinoa protein is about 7% w/w, and rice protein is about 9% w/w.

13. The method of claim 10, wherein the plant-based protein composition further comprises a flavoring agent and a sweetener.

14. The method of claim 10, wherein the plant-based protein composition provides about 20 grams of plant-based protein per serving.

15. The method of claim 10, wherein the plant-based protein composition provides an in-vitro digestibility of essential amino acids at about 72.2% histidine, about 82.1% isoleucine, about 75.7% leucine, about 77.4% lysine, about 51.5% methionine, about 73.1% phenylalanine, about 72.8% tryptophan, and about 70.7% valine.

16. The method of any one of claims 10, wherein the plant-based protein composition provides about 90% comparable digestibility to milk protein.

17. The method of claim 10, wherein the plant-based protein composition is provided at least one, two, three, four or five times per day.

18. The method of claim 10, wherein the plant-based protein composition is provided at a meal.

19. The method of claim 10, wherein the plant-based protein composition is provided in a beverage to the subject.

20. A plant-based wellness protein shake product that is absent of soy and dairy products, comprising:
about 90% to 99% of a plant-based protein composition; and
about 1% to about 10% water,
wherein the plant-based protein composition comprises a flax protein, a pea protein, a quinoa protein, and a rice protein.

21. A method of making a plant-based protein shake product that is absent of soy and dairy products, the method comprising:
mixing a plant-based protein composition in water to achieve a desired thickness,
wherein the plant-based protein composition comprises a flax protein, a pea protein, a quinoa protein, and a rice protein.

22. The method of claim 21, wherein the mixing is in a blender.

23. The method of claim 21, further comprising adding ice to the plant-based protein composition in water.

24. The method of claim 1, further comprising adding fresh fruits and vegetables to the plant-based protein composition in water.
